(19) United States
(12) Patent Application Publication
(10) Pub. No.: US 2011/0291949 A1
(43) Pub. Date: Dec. 1, 2011

(54) PALMTOP ELECTRONIC PRODUCT

(75) Inventors: FONG-GONG WU, TAINAN CITY (TW); HAN-CHI HSIAO, CHANGHUA COUNTY (TW)

(73) Assignee: NATIONAL CHENG KUNG UNIVERSITY, TAINAN CITY (TW)

(21) Appl. No.: 12/789,786

(22) Filed: May 28, 2010

(51) Int. Cl. G06F 3/041

(52) U.S. Cl. 345/173

(57) ABSTRACT

A palmtop electronic product includes a casing having opposite first and second sides. A screen is mounted to the first side of the casing. A first input unit is mounted to the second side of the casing. A control unit is mounted in the casing and electrically connected to the screen and the first input unit. The first input unit can be pressed or touched by a user, and the control unit generates an input signal when the first input unit is pressed or touched by the user. The input signal is processed by the control unit, and the processing result of the input signal being displayed on the screen.

### BACKGROUND OF THE INVENTION

The present invention relates to an electronic product and, more particularly, to a palmtop electronic product.

Electronic products generally include a plurality of buttons allowing a user to perform functional operations through pressing the buttons. Palmtop electronic products such as cell phones, palmtop electronic game consoles, or the like generally include a screen. The screen and the buttons are on the same side of the palmtop electronic product. However, the disposition of the keys and the screen on the same side results in an unaesthetic appearance, which is particularly true for electronic products with more buttons such as cell phones. Thus, these electronic products can not meet both needs in aesthetic appearance and utility, failing to attract the young that are more interested in products with cool appearances and, thus, adversely affecting the market share. Electronic products such as cell phones providing functions of text messages and notebooks require input of texts through buttons. When fewer buttons and the screen are provided on the same side of the cell phone, the input speed of texts by using the buttons is no comparison to a computer keypad.

Thus, a need exists for a palmtop electronic product that has an aesthetic appearance while allowing rapid input of texts.

### BRIEF SUMMARY OF THE INVENTION

The present invention solves this need and other problems in the field of aesthetic palmtop electronic devices without sacrificing input speed by providing, in a preferred form, a palmtop electronic product includes a casing having opposite first and second sides. A screen is mounted to the first side of the casing. A first input unit is mounted to the second side of the casing. A control unit is mounted in the casing and electrically connected to the screen and the first input unit. The first input unit can be pressed or touched by a user, and the control unit generates an input signal when the first input unit is pressed or touched by the user. The input signal is processed by the control unit, and the processing result of the input signal being displayed on the screen.

In a preferred form, the second side of the casing includes left and right portions. The palmtop electronic product further includes a second input unit, a third input unit, a forth input unit, a fifth input unit, a sixth input unit, a seventh input unit, an eighth input unit, a ninth input unit, and a tenth input unit. The first, second, third, fourth, and fifth input units are mounted in sequence from top to bottom on the right portion and spaced from each other. The sixth, seventh, eighth, ninth, and tenth input units are mounted in sequence from top to bottom on the left portion and spaced from each other. The control unit generates a character signal indicative of one of characters “B”, “G”, and “T” for selection by the user when the first input unit is pressed or touched. The control unit generates a character signal indicative of one of characters “V”, “F”, and “R” for selection by the user when the second input unit is pressed or touched. The control unit generating a character signal indicative of one of characters “C”, “D”, and “E” for selection by the user when the third input unit is pressed or touched. The control unit generates a character signal indicative of one of characters “X”, “S”, and “W” for selection by the user when the fourth input unit is pressed or touched. The control unit generates a character signal indicative of one of characters “Z”, “A”, and “Q” for selection by the user when the fifth input unit is pressed or touched. The control unit generates a character signal indicative of one of characters “N”, “H”, and “Y” for selection by the user when the sixth input unit is pressed or touched. The control unit generates a character signal indicative of one of characters “M”, “J”, and “U” for selection by the user when the seventh input unit is pressed or touched. The control unit generates a character signal indicative of one of characters “,”, “K”, and “I” for selection by the user when the eighth input unit is pressed or touched. The control unit generates a character signal indicative of one of characters “.”, “L”, and “O” for selection by the user when the ninth input unit is pressed or touched. The control unit generating a character signal indicative of one of characters “/”, “;”, and “P” for selection by the user when the tenth input unit is pressed or touched. Thus, the user can operate the palmtop electronic product according to the teachings of the present invention in a way similar to using a standard keyboard, allowing rapid typing.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a front, perspective view of a palmtop electronic product of a first embodiment according to the preferred teachings of the present invention.

FIG. 2 shows a rear, perspective view of the palmtop electronic product of FIG. 1.

FIG. 3 shows a perspective view illustrating operation of the palmtop electronic product of FIG. 1.

FIG. 4 shows a rear, perspective view of a palmtop electronic product of a second embodiment according to the preferred teachings of the present invention.

FIG. 5 shows a rear, perspective view of a palmtop electronic product of a third embodiment according to the preferred teachings of the present invention.

FIG. 5A shows an enlarged view of a circled portion of FIG. 5.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

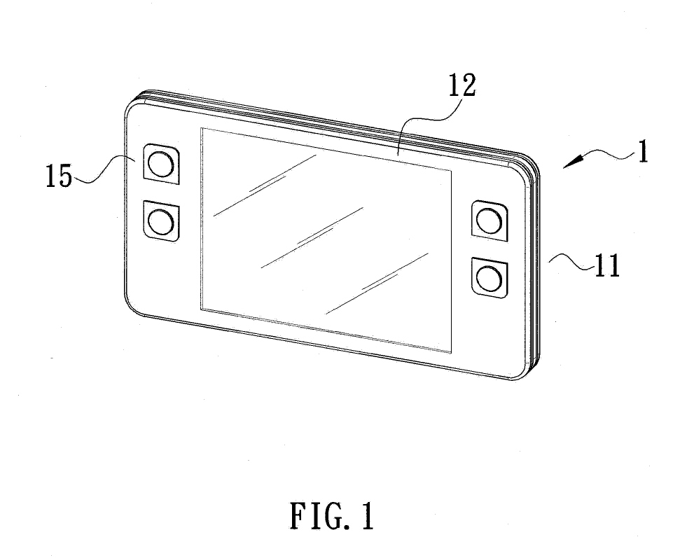

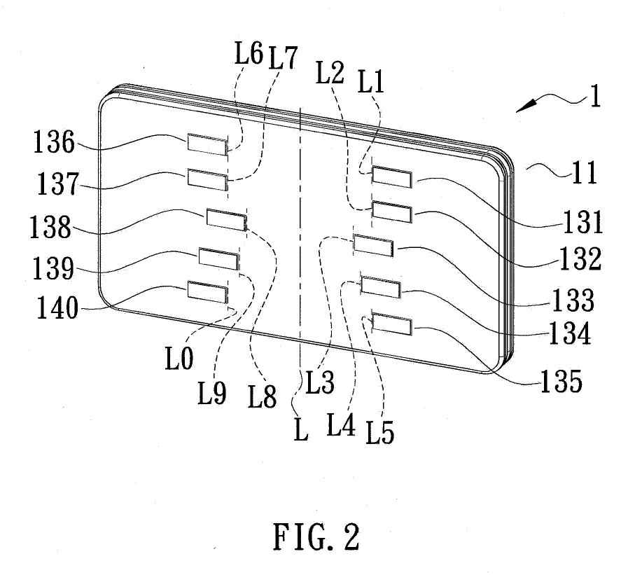

A palmtop electronic product 1 of a first embodiment according to the preferred teachings of the present invention is shown in FIGS. 1 and 2 and generally includes a casing 11 having opposite first and second sides. A screen 12 is mounted to the first side of the casing 11. A first input unit 131 is mounted to the second side of the casing 11. A control unit is mounted in the casing 11 and electrically connected to the screen 12 and the first input unit 131. The palmtop electronic product 1 can be, but not limited to, a cell phone, an electronic game console, or a translator. Hereinafter, the structure, characteristics, and use of the palmtop electronic product 1 according to the teachings of the present invention will be described by way of example of a cell phone. Specifically, the control unit generates an input signal when the first input unit 131 is pressed or touched by a user. The input signal is processed by the control unit, and the processing result of the input signal is displayed on the screen 12. Since the first input unit 131 is disposed on the second side opposite to the first side where the screen 12 is disposed, the user can press or touch the first input unit 131 with his or her index finger, middle finger, ring finger, or little finger when using the palmtop electronic product 1. Thus, use of the palmtop electronic product 1 such as checking an electronic calendar and dialing is convenient. Furthermore, compared to conventional electronic products such as cell phones with a monotonous appearance due to disposition of the input unit and screen on the same side, the palmtop electronic product 1 according to the preferred teachings of the present invention can have differing styles according to design needs for attracting the young and, thus, can increase the market share.

With reference to FIG. 2, the second side of the casing 11 opposite to screen 12 includes left and right portions 13. The palmtop electronic product 1 further includes a second input unit 132, a third input unit 133, a forth input unit 134, a fifth input unit 135, a sixth input unit 136, a seventh input unit 137, an eighth input unit 138, a ninth input unit 139, and a tenth input unit 140. The first, second, third, fourth, and fifth input units 131-135 are mounted in sequence from top to bottom on the right portion 13 and spaced from each other. The sixth, seventh, eighth, ninth, and tenth input units 136-140 are mounted in sequence from top to bottom on the left portion 13 and spaced from each other.

The control unit generates a character signal indicative of one of characters “B”, “G”, and “T” for selection by the user when the first input unit 131 is pressed or touched. As an example, the control unit generates a character signal indicative of character “B” when the first input unit 131 is pressed or touched once. The control unit generates a character signal indicative of character “G” when the first input unit 131 is pressed or touched twice. The control unit generates a character signal indicative of character “T” when the first input unit 131 is pressed or touched thrice. The control unit generates a character signal indicative of character “B” when the first input unit 131 is pressed or touched four times. The character is shown on the screen 12 after the character signal is processed by the control unit. The character sequence of repeatedly pressing or touching the first input unit 131 is not limited to “B”, “G”, and “T”. As an example, the character sequence of repeatedly pressing or touching the first input unit 131 can be “G”, “B”, and “T”. Likewise, the control unit generates a character signal indicative of one of characters “V”, “F”, and “R” for selection by the user when the second input unit 132 is pressed or touched. The control unit generates a character signal indicative of one of characters “C”, “D”, and “E” for selection by the user when the third input unit 133 is pressed or touched. The control unit generates a character signal indicative of one of characters “X”, “S”, and “W” for selection by the user when the fourth input unit 134 is pressed or touched. The control unit generates a character signal indicative of one of characters “Z”, “A”, and “Q” for selection by the user when the fifth input unit 135 is pressed or touched. The control unit generates a character signal indicative of one of characters “N”, “H”, and “Y” for selection by the user when the sixth input unit 136 is pressed or touched. The control unit generates a character signal indicative of one of characters “M”, “J”, and “U” for selection by the user when the seventh input unit 137 is pressed or touched. The control unit generates a character signal indicative of one of characters “,”, “K”, and “I” for selection by the user when the eighth input unit 138 is pressed or touched. The control unit generates a character signal indicative of one of characters “.”, “L”, and “O” for selection by the user when the ninth input unit 139 is pressed or touched. The control unit generates a character signal indicative of one of characters “/”, “;”, and “P” for selection by the user when the tenth input unit 140 is pressed or touched.

The characters can be of other types, such as Mandarin phonetic symbols. As an example, the control unit generates a character signal indicative of one of Mandarin phonetic symbols [symbol] and [symbol] for selection by the user when the first input unit 131 is pressed or touched. Alternatively, the characters can be Chinese character elements for Chang Jie (a Chinese input system). As an example, the control unit generates a character signal indicative of one of Mandarin phonetic symbols [symbol] and [symbol] for selection by the user when the first input unit 131 is pressed or touched.

Since people today are used to standard keyboards, the user can press or touch the first and second units 131 and 132 with the index finger of the right hand, press or touch the third input unit 133 with the middle finger of the right hand, press or touch the fourth input unit 134 with the ring finger of the right hand, press or touch the fifth input unit 135 with the little finger of the right hand, press or touch the sixth and seventh input units 136 and 137 with the index finger of the left hand, press or touch the eighth input unit 138 with the middle finger of the left hand, press or touch the ninth input unit 139 with the ring finger of the left hand, and press or touch the tenth input unit 140 with the little finger of the left hand. Since the fingers of both hands of the user presses or touches the first through tenth input units 131-140 to control the characters in a way similar to that of using a standard keyboard, the time required for typing is shortened. With reference to FIG. 1, the casing 11 further includes a plurality of auxiliary buttons 15 on two sides of the screen 12. The control unit generates input signals indicative of “Caps Lock”, “Enter”, “Space”, and “Del” when the auxiliary buttons 15 are pressed or touched, respectively. Since the auxiliary buttons 15 and the screen 12 are provided on the side same of the casing 11, the user can operate the auxiliary buttons 15 with the thumbs of both hands while the remaining fingers can control the first through tenth input units 131-140 on the opposite side. Thus, the user can have the same feeling as using a standard keyboard while using the palmtop electronic product 1 according to the teachings of the present invention, providing rapid and convenient tying.

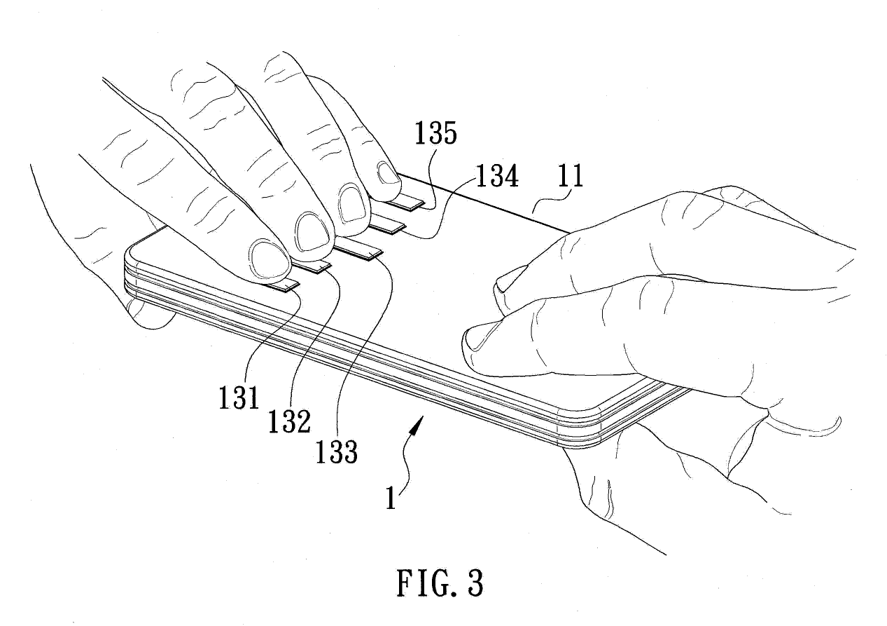

With reference to FIG. 2, the second side of the casing 12 includes an imaginary dividing line L intermediate the left and right portions 13. Each of the first through tenth input units 131-140 has an edge adjacent the imaginary dividing line L1. The first, second, third, fourth, fifth, sixth, seventh, eighth, ninth, and tenth input units 131-140 respectively have first, second, third, fourth, fifth, sixth, seventh, eighth, ninth, and tenth imaginary lines L1-L10 passing through the edges of the first through tenth input units 131-140 and parallel to the imaginary dividing line L. A spacing between each of the second imaginary line L2 and the fourth imaginary line L4 and the imaginary dividing line L is larger than a spacing between the third imaginary line L3 and the imaginary dividing line L. A spacing between each of the seventh imaginary line L7 and the ninth imaginary line L9 and the imaginary dividing line L is larger than a spacing between the eighth imaginary line L8 and the imaginary dividing line L. A spacing between the first imaginary line L1 and the imaginary dividing line L is larger or equal to a spacing between the second imaginary line L2 and the imaginary dividing line L. A spacing between the sixth imaginary line L6 and the imaginary dividing line L is larger or equal to a spacing between the seventh imaginary line L7 and the imaginary dividing line L. A spacing between the fifth imaginary line L5 and the imaginary dividing line L is larger than a spacing between the fourth imaginary line L4 and the imaginary dividing line L. A spacing between the tenth imaginary line L10 and the imaginary dividing line L is larger than a spacing between the ninth imaginary line L9 and the imaginary dividing line L. Thus, the input units 136-140 on the left portion 13 of the casing 11 and the input units 131-135 on the right portion 13 of the casing 11 are arranged in an arcuate manner. This allows the user to easily and conveniently operate the input units 131-140 through the fingers having differing lengths, as shown in FIG. 3.

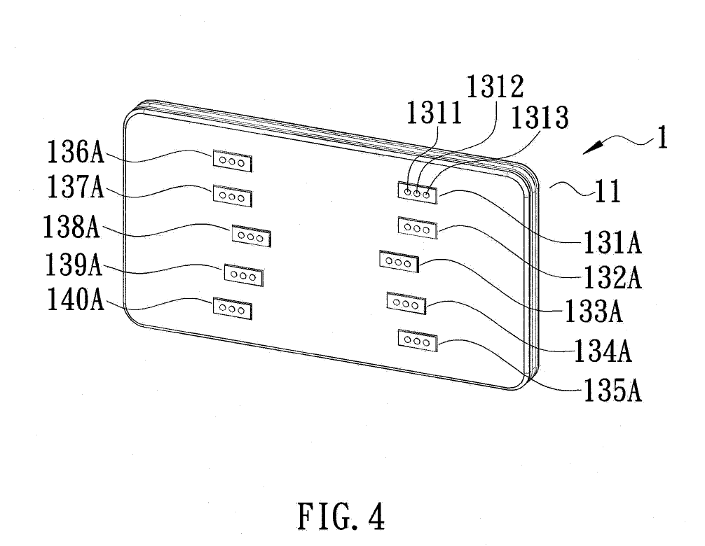

FIG. 4 shows a palmtop electronic product 1 of a second embodiment according to the teachings of the present invention, wherein the first input unit 131A includes spaced first, second, and third buttons 1311, 1312, and 1313. The control unit generates differing input signals when the first, second, and third buttons 1311, 1312, and 1313 are pressed or touched. As an example, the control unit generates a character signal indicative of character “B” when the first button 1311 is pressed or touched. The control unit generates a character signal indicative of character “G” when the second button 1312 is pressed or touched. The control unit generates a character signal indicative of character “T” when the third button 1313 is pressed or touched. Each of the second through tenth input signals 132A-140A have three buttons and can be operated in a similar way such that the control unit generates a character signal indicative of one of the corresponding characters for selection by the user. The time required for inputting the characters is also reduced by using the palmtop electronic product 1 of this embodiment.

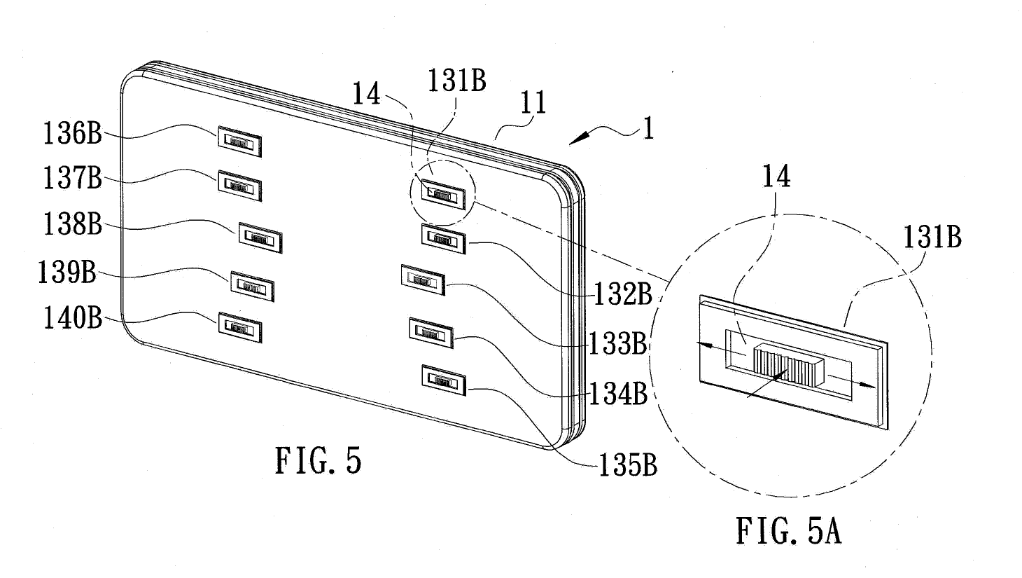

FIGS. 5 and 5A show a palmtop electronic product 1 of a third embodiment according to the teachings of the present invention, wherein the second side of the casing 11 includes ten grooves 14, and the first through tenth input units 131B-140B are respectively and slideably received in the grooves 14 in a horizontal direction. Taking the first input unit 131B as an example, the control unit generates a character signal indicative of character “B” when the first input unit 131B is moved or slid rightward once. The control unit generates a character signal indicative of character “G” when the first input unit 131B is moved or slid rightward twice. The control unit generates a character signal indicative of character “T” when the first input unit 131B is moved or slid rightward thrice. The control unit generates a character signal indicative of character “B” when the first input unit 131B is moved or slid rightward four times. The control unit generates a character signal indicative of character “T”, “G”, or “B” when the first input unit 131B is moved or slid leftward once, twice, or thrice. It can be appreciated that the character sequence of repeatedly moving or sliding the first input unit 131B rightward is not limited to “B”, “G”, and “T”. As an example, the character sequence of repeatedly moving or sliding the first input unit 131B rightward can be “G”, “B”, and “T”. The second through tenth input units 132B-140B can be operated in a similar way. Thus, the time required for inputting the characters is also reduced by using the palmtop electronic product 1 of this embodiment.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A palmtop electronic product comprising:
a casing including opposite first and second sides;
a screen mounted to the first side of the casing;
a first input unit mounted to the second side of the casing; and
a control unit mounted in the casing and electrically connected to the screen and the first input unit, with the first input unit adapted to be pressed or touched by a user, with the control unit generating an input signal when the first input unit is pressed or touched by the user, with the input signal being processed by the control unit, with a processing result of the input signal being displayed on the screen.

2. The palmtop electronic product as claimed in claim 1, with the second side of the casing including left and right portions, with the palmtop electronic product further comprising a second input unit, a third input unit, a forth input unit, a fifth input unit, a sixth input unit, a seventh input unit, an eighth input unit, a ninth input unit, and a tenth input unit, with the first, second, third, fourth, and fifth input units mounted in sequence from top to bottom on the right portion and spaced from each other, with the sixth, seventh, eighth, ninth, and tenth input units mounted in sequence from top to bottom on the left portion and spaced from each other, with the control unit generating a character signal indicative of one of characters “B”, “G”, and “T” for selection by the user when the first input unit is pressed or touched, with the control unit generating a character signal indicative of one of characters “V”, “F”, and “R” for selection by the user when the second input unit is pressed or touched, with the control unit generating a character signal indicative of one of characters “C”, “D”, and “E” for selection by the user when the third input unit is pressed or touched, with the control unit generating a character signal indicative of one of characters “X”, “S”, and “W” for selection by the user when the fourth input unit is pressed or touched, with the control unit generating a character signal indicative of one of characters “Z”, “A”, and “Q” for selection by the user when the fifth input unit is pressed or touched, with the control unit generating a character signal indicative of one of characters “N”, “H”, and “Y” for selection by the user when the sixth input unit is pressed or touched, with the control unit generating a character signal indicative of one of characters “M”, “J”, and “U” for selection by the user when the seventh input unit is pressed or touched, with the control unit generating a character signal indicative of one of characters “,”, “K”, and “I” for selection by the user when the eighth input unit is pressed or touched, with the control unit generating a character signal indicative of one of characters “.”, “L”, and “O” for selection by the user when the ninth input unit is pressed or touched, with the control unit generating a character signal indicative of one of characters “/”, “;”, and “P” for selection by the user when the tenth input unit is pressed or touched.

3. The palmtop electronic product as claimed in claim 2, with the second side of the casing including an imaginary dividing line intermediate the left and right portions, with each of the first, second, third, fourth, fifth, sixth, seventh, eighth, ninth, and tenth input units having an edge adjacent the imaginary dividing line, with the first, second, third, fourth, fifth, sixth, seventh, eighth, ninth, and tenth input units respectively having first, second, third, fourth, fifth, sixth, seventh, eighth, ninth, and tenth imaginary lines and parallel to the imaginary dividing line, with a spacing between each of the second imaginary line and the fourth imaginary line being larger than a spacing between the third imaginary line and the imaginary dividing line, with a spacing between each of the seventh imaginary line and the ninth imaginary line and the imaginary line being larger than a spacing between the eighth imaginary line and the imaginary dividing line, with a spacing between the first imaginary line and the imaginary dividing line being larger or equal to a spacing between the second imaginary line and the imaginary dividing line, with a spacing between the sixth imaginary line and the imaginary dividing line being larger or equal to a spacing between the seventh imaginary line and the imaginary dividing line, with a spacing between the fifth imaginary line and the imaginary dividing line being larger than a spacing between the fourth imaginary line and the imaginary dividing line, with a spacing between the tenth imaginary line and the imaginary dividing line being larger than a spacing between the ninth imaginary line and the imaginary dividing line.

4. The palmtop electronic product as claimed in claim 1, with the first input unit including a plurality of spaced buttons, with the control unit generating a plurality of differing input signals when the plurality of buttons is pressed or touched.

5. The palmtop electronic product as claimed in claim 1, with the second side of the casing including a groove, with the first input unit slideably received in the groove in a horizontal direction, with the control unit generating the input signal when the first input unit is moved in the horizontal direction.

6. The palmtop electronic product as claimed in claim 5, with the control unit generating the input signal when the first input unit is pressed.
